(19) United States
(12) Patent Application Publication
(10) Pub. No.: US 2012/0195047 A1
(43) Pub. Date: Aug. 2, 2012

(54) LIGHTING APPARATUS AND SELECTING METHOD FOR SELECTING HUE OF TONER IN MEDIUM LAYER THEREOF

(75) Inventors: CHIH-LUNG LIANG, TAIPEI CITY (TW); SHU-HUA YANG, TAICHUNG CITY (TW)

(73) Assignees: LITE-ON TECHNOLOGY CORPORATION, Taipei City (TW); SILITEK ELECTRONIC (GUANGZHOU) CO., LTD., Guangzhou (CN)

(21) Appl. No.: 13/345,799

(22) Filed: Jan. 9, 2012

Related U.S. Application Data
(60) Provisional application No. 61/438,329, filed on Feb. 1, 2011.

(51) Int. Cl. F21V 9/00

(52) U.S. Cl. 362/293

(57) ABSTRACT

A lighting apparatus having a light source and at least a medium layer is provided. The light source emits a first light beam with a first main wavelength and a second main wavelength, wherein the first main wavelength is less than the second main wavelength. The medium layer is allocated corresponding to the light source. The medium layer has a transmittance not less than 60% and a toner mixed therein. After the first light beam passes through the medium layer, a peak attenuation of the first main wavelength is larger than that of the second main wavelength.

### CROSS-REFERENCE TO RELATED APPLICATION

This application claims priority of U.S. provisional application No. 61/438,329, filed on Feb. 1, 2011. The entirety of each of the above-mentioned patent applications is hereby incorporated by reference herein and made a part of this specification.

### BACKGROUND

1. Technical Field

The present disclosure relates to a lighting apparatus, in particular, to a lighting apparatus having a medium layer, and to a selecting method for selecting a hue of the toner in the medium layer thereof

2. Description of Related Art

There are many types of lighting apparatus available currently on the market for consumers to choose from, including lighting apparatuses using incandescent lamp, fluorescent lamp, or light-emitting diodes (LEDs) lamp. In comparison to the conventional lighting apparatuses such as the incandescent lamp and the fluorescent lamp, the color temperature variations associated with the LED lamp may be selected according to the needs of the consumers. Consequently, LED lamp may provide variety of color temperatures for consumers to choose.

In order to fabricate LED lamp having the high color uniformity, the lighting apparatus manufacturer may only acquire certain LED specifications. Further, once light-emitting diodes have been selected and disposed in a lighting apparatus, the associated color temperature is thereby determined and may not be modified.

### SUMMARY

An exemplary embodiment of the present disclosure provides a lighting apparatus and a selecting method for selecting a hue of the toner in a medium layer thereof, so as to modify properties associated with a light beam after the light beam passes through the medium layer.

An exemplary embodiment of the present disclosure provides a lighting apparatus having a light source and at least a medium layer. The light source emits a first light beam with a first main wavelength and a second main wavelength, wherein the first main wavelength is less than the second main wavelength. The medium layer is allocated corresponding to the light source. The medium layer has a transmittance not less than 60% and a toner mixed therein. After the first light beam passes through the medium layer, a peak attenuation of the first main wavelength is larger than that of the second main wavelength.

An exemplary embodiment of the present disclosure provides a lighting apparatus having a light source and at least a medium layer. The light source emits a light beam, wherein an absolute value of a color deviation (i.e. |duv|) between the first light beam and a blackbody locus is larger than 0.006. The medium layer is allocated on an optical path of the light source. The medium layer mixed with at least a toner and has a transmittance not less than 60%. A second light beam is generated after the first light beam passes through the medium layer. An absolute value of a color deviation between the second light beam and the blackbody locus is less than that between the first light beam and the blackbody locus.

Another exemplary embodiment of the present disclosure provides a selecting method for selecting a hue of a toner in a medium layer of the aforementioned lighting apparatus. First, a plurality of boundary color coordinate point lines by respectively connecting each of a plurality of first boundary color coordinate points in a chromaticity region associated with the first light beam to one of a plurality of second boundary color coordinate points corresponding to the respective first boundary color coordinate point in a chromaticity region associated with the second light beam is formed. Next, a toner chromaticity region enclosed by the boundary color coordinate point lines and a saturation curve is formed. Then, the hue of the toner from the toner chromaticity region is selected.

Accordingly, the medium layer of the lighting apparatus according to the present disclosure can modify the properties associated with a light beam emitted by a light source after the light beam passes through the medium layer. The modifications may be variations in the wavelength, the color deviation in accordance to the blackbody locus, or the color temperature. Further, the optical efficiency of the illumination light beam, i.e. a light beam passing through the medium layer, may not be degraded due to existence of the medium layer. In addition, the medium layer is replaceable whereby the applications and flexibility of the lighting apparatus would be enhanced.

In order to further understand the techniques, means and effects the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a schematic diagram of a lighting apparatus in accordance with an exemplary embodiment of the present disclosure.

FIG. 2 is a spectral flux plot for the first and second light beams associated with a lighting apparatus in accordance with an exemplary embodiment of the present disclosure.

FIG. 3 is a chromaticity diagram for the first and second light beams of a lighting apparatus in accordance with an exemplary embodiment of the present disclosure.

FIG. 4 is a schematic plot of color temperature adjustment curves with respect to different yellow toner concentrations of a medium layer disposed in a lighting apparatus in accordance with an exemplary embodiment of the present disclosure.

FIG. 5 is a spectral flux diagram of the second beam corresponding to a medium layer of a lighting apparatus mixed with different toners therein in accordance with an exemplary embodiment of the present disclosure.

FIG. 6 is a schematic diagram for a chromaticity region in accordance with an exemplary embodiment of the present disclosure.

FIG. 7 is a schematic diagram showing a Munsell color system in accordance with an exemplary embodiment of the present disclosure.

FIG. 8 is a sectional view of a lighting apparatus in accordance with an exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

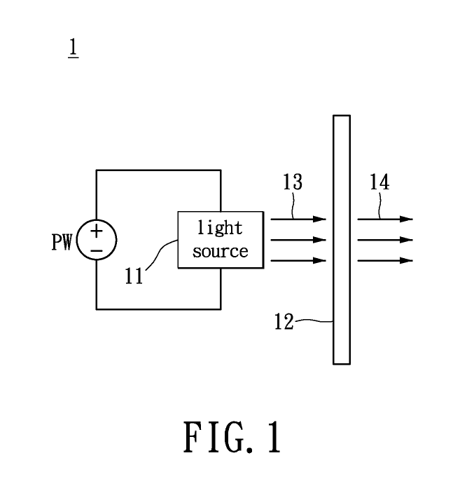

Please refer to FIG. 1. A lighting apparatus 1 includes a light source 11, a power source PW and a medium layer 12. The medium layer 12 is allocated corresponding to the light source 11, or specifically the medium layer 12 is allocated on an optical path (not shown) of the light source 11. The medium layer 12 may substantially surround the light source 11, and further other medium layers may be disposed between the medium layer 12 and the light source 11. The power source PW may include one or more transformers and one or more AC to DC converters. The light source 11 may have one or more light-emitting diodes, but the light source 11 may also be formed by other lighting elements, and the present disclosure is not limited thereto.

The light source 11 may be disposed on the base (not shown in FIG. 1). The power source PW is used for powering the light source 11 so that the light-emitting diodes of the light source 11 may emit a first light beam 13 having a first color temperature. The first light beam 13 has a first main wavelength and a second main wavelength, in which the first main wavelength is less than the second main wavelength. The medium layer 12 has a toner mixed therein. After the first light beam 13 passes through the medium layer 12, the first main wavelength and the second main wavelength have respective peak attenuations, and the peak attenuation of the first main wavelength is larger than the peak attenuation of the second main wavelength.

Moreover, the medium layer 12 may substantially be a transparent or translucent medium layer, preferable with a transmittance not less than 60%. When the first light beam 13 passes through the medium layer 12, the medium layer 12 attenuates the spectral flux associated with fractional wavelength of the first light beam 13 and generates a second light beam 14 having a second color temperature accordingly, in which the first color temperature is lager than the second color temperature. Additionally, the first light beam 13 has an absolute value of a color deviation (i.e. |duv|) from a blackbody locus larger than 0.006, and the second light beam 14 has an absolute value of a color deviation from the blackbody locus less than that of the first light beam.

Consequently, if a light beam emitted by the one or more light-emitting diodes in the light source 11 has a higher color temperature (for example greater than 7000K), and the color temperature of the light beam may be significantly reduced after the light beam passes through the medium layer 12. Conversely, if a light beam emitted by the one or more light-emitting diodes of the light source 11 has a moderate or lower color temperature (for example less than 7000K), and the color temperature of the light beam may be lightly reduced after the light beam passes through the medium layer 12. In other words, the color temperature (i.e. the first color temperature) of the first light beam 13 emitted by the light source 11 is higher than the color temperature (i.e. the second color temperature) of the second light beam 14 which is generated by passing through the medium layer 12. For instance, the first color temperature may lie in the range of 7000K to 13000K, whereas the second color temperature may lie in the range of 5500K to 6800K or 6000K to 6800K depending on the factors, such as the toner concentration or the thickness of the medium layer 12.

The medium layer 12 may be replaced or exchanged according to the needs of users. Consequently, the lighting apparatus 1 may generate the second light beam 14 with various color temperatures in accordance to various applications. The lighting apparatus manufacturers may purchase various types of light-emitting diodes instead of light-emitting diodes with certain specifications, and therefore the fabrication cost of the lighting apparatus 1 would be lowered.

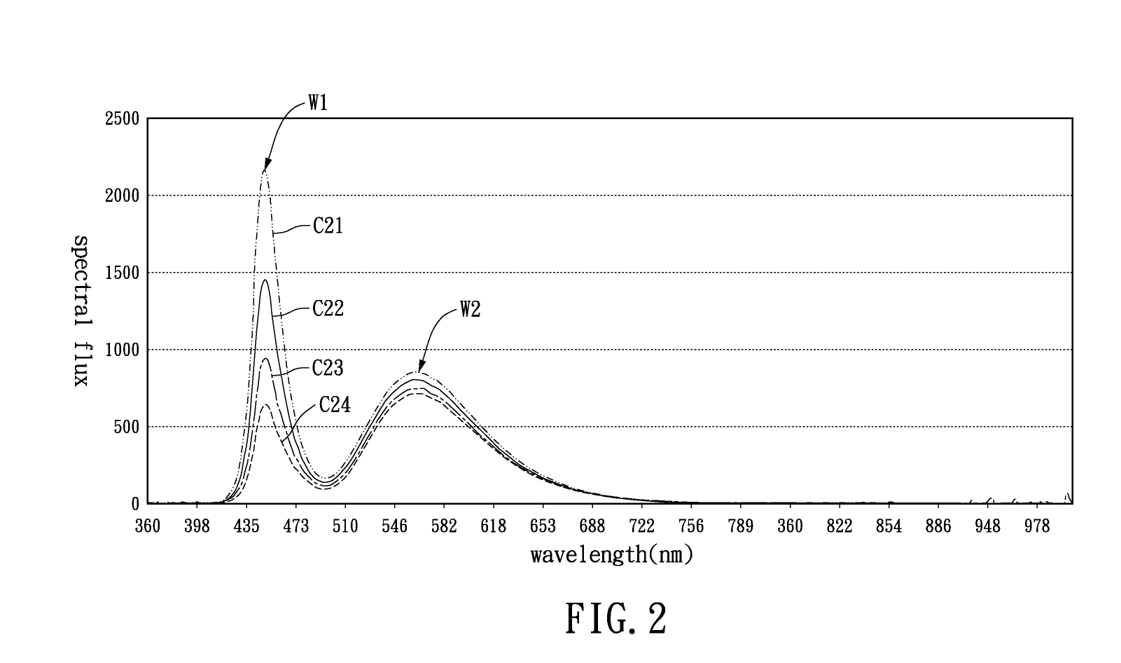

As shown in FIG. 2, a light source emits a first light beam having the first color temperature of 8770K. The first light beam passes through the medium layer, and a second light beam having the second color temperature is generated thereby. The curve C21 represents a spectral flux curve of the first light beam and the curves C22, C23, and C24 represent spectral flux curves of the second light beam with the thickness of the medium layer being 0.14 mm, 0.28 mm, and 0.42 mm, respectively.

In FIG. 2, the medium layer significantly reduces the peak amplitude of the spectral flux associated with the first main wavelength W1 (the approximate range of 435 nm to 473 nm), with the peak attenuation may be as much as 33.2%. However, the peak amplitude of the spectral flux associated with the second main wavelength W2 (the approximate range of 546 nm to 582 nm) on the other hand reduced only slightly by 5.6%. The first light beam can be divided into two kinds of bands, one is lower than 500 nm (hereinafter referred to as a blue band) and the other is higher than 500 nm (hereinafter referred to as the other band). In other words, supposing the first beam having the first color temperature of 8770K passes through the medium layer, then the spectral flux attenuation associated with the blue band (the first main wavelength W1 is included therein) may be higher than the spectral flux attenuation associated with the other bands (the second main wavelength W2 is included therein). Hence the second color temperature of the second light beam is lower than the first color temperature of the first light beam.

Specifically, the peak of the first main wavelength W1 located the blue band may be significantly reduced while the peak attenuation associated with the second main wavelength W2 in the other band is not high. Moreover, the weighting of the relative spectral luminous efficiency curve in associated with the blue band to the human eye is not high, and therefore the blue band occupies relatively small proportion in the computation of optical efficiency. Thus in comparison to a lighting apparatus without the medium layer, the present lighting apparatus with the medium layer in this embodiment may have relatively low loss in the optical efficiency.

It may be observed from curves C22 to C24 of FIG. 2, the spectral flux attenuation of the blue band associated with the first beam increases (i.e. the peak attenuation in the first main wavelength W1 becomes higher) as the thickness of the medium layer increases, whereas the second color temperature of the second light beam becomes relatively low. Moreover, the second color temperature of the second light beam may be varied through adjusting the thickness of the medium layer as well as through modifying the color and the concentration of the toner in the medium layer. In this embodiment, the medium layer may be a transparent plastic material or a transparent glass material mixed with the toner, in which the toner may be a power toner or a liquid toner. The toner may include a yellow toner, and in the other embodiments, the toner may further include a red toner.

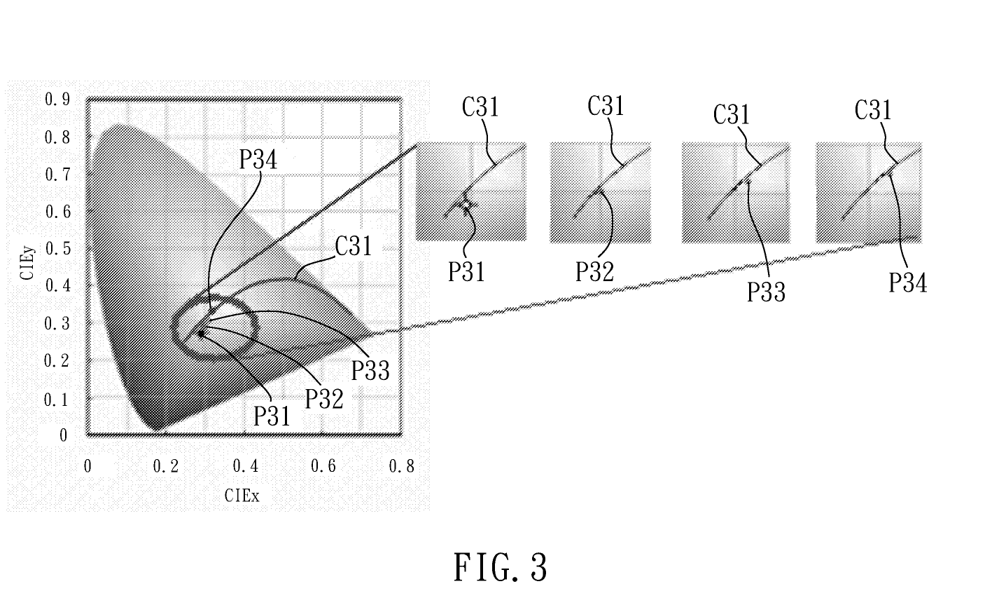

Next, please refer to FIG. 3, which is a chromaticity diagram in correspondence to the standard of the International Commission on Illumination 1931 (CIE1931) for the first and second light beams of a lighting apparatus. The curve C31 represents a blackbody locus. Generally, the chromaticity of a color in the chromaticity diagram away from the blackbody locus C31 appears to be bluish, while a visible light with a bluish color may make people depressed and uneasy.

The deviation level between the chromaticity of a color and the blackbody locus C31 may be represented by a color deviation, denoted as duv, wherein the color deviation describes the shortest distance between the chromaticity of the color and the blackbody locus C31. For general lighting, the absolute value of color derivation associated with a light beam should be less than 0.006.

As shown in FIG. 3, the color coordinate point P31 represents a chromaticity of a first light beam emitted by the light source, and the color temperature of the first light beam is 10040K. The color coordinate points P32, P33, P34 respectively represents chromaticities of the second light beam in accordance to the thickness of the medium layer being 0.061 mm, 0.122 mm and 0.183 mm.

In FIG. 3, the color coordinate point P34 with the thickness of the medium layer being 0.183 mm almost lies on the blackbody locus C31. After the light beam passes through the medium layer of the present lighting apparatus, not only may lower the associated color temperature but also adjust the color deviation associated with the light beam. Hence, the generated second light beam has a chromaticity approaching the blackbody locus C31. By adopting the present medium layer, even a light source emitting light beams away from the blackbody locus may be used in the present lighting apparatus.

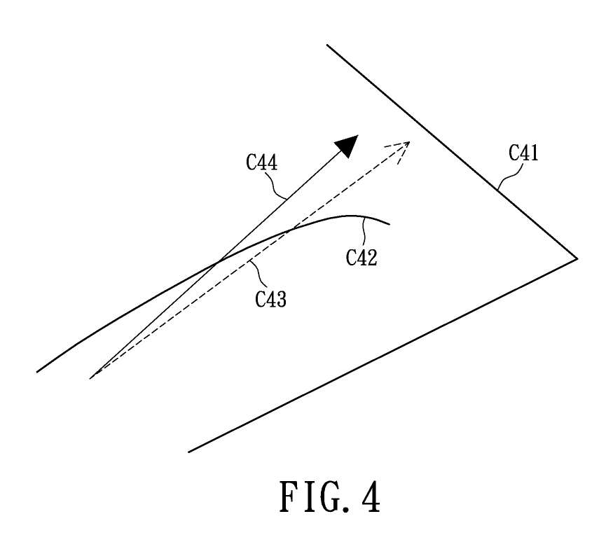

Please refer to FIG. 4. According to the CIE1931 chromaticity diagram, the curve C41 corresponds to the saturation curve of the CIE 1931 chromaticity diagram. The curve C42 represents the blackbody locus. Curves C43, C44 represent respective color temperature adjustment curves in correspondence to different yellow toner concentrations of the medium layer.

It may be noted from FIG. 4, the yellow toner concentration of the medium layer may be adjusted in accordance to various lighting applications and quality requirements, and therefore the slope of the color temperature adjustment curve is varied (for example, the curve C44 is translated to the curve C43). Similarly, the shortest distance between the blackbody locus C42 and the chromaticity associated with the second color temperature may be adjusted by changing the intersection point between the color temperature adjustment curve and the blackbody locus C42.

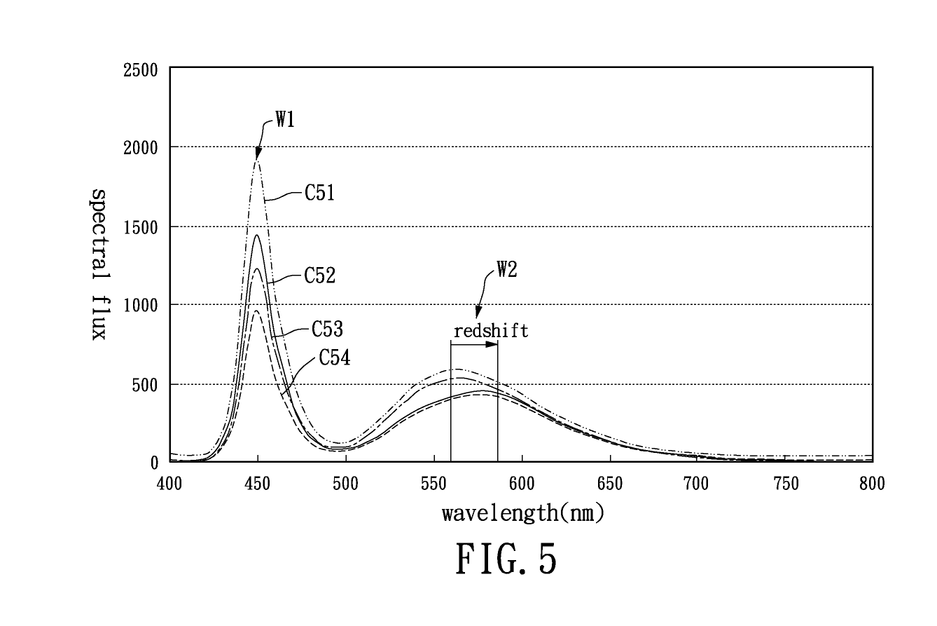

Moreover, as the spectral flux of the fractional wavelength may be reduced after the first light beam passes through the described medium layer, and thus the general color rendering index, i.e. Ra, of the generated second light beam may be slightly reduced as well. The general color rendering index Ra may be used to evaluate the lighting quality. In order to enhance the lighting quality, few amounts of a red toner would be added into the medium layer besides the yellow toner. That is to say, a long wavelength portion of the main wavelength (e.g., the second main wavelength W2 of FIG. 1) in the spectral flux is shifted right (i.e., redshift), as shown in FIG. 5, and therefore the general color rendering index Ra and lighting quality of the second light beam would be enhanced.

In FIG. 5, the curve C51 represents the spectral flux curve associated with the first light beam, and Curves C52 to C54 represent the spectral flux curves associated with the second light beam of respective medium layers having the red toner, the yellow toner, and both of them mixed therein.

It may be noted from FIG. 5, when the medium layer mixes with the red toner, the peak attenuation of the first main wavelength W1 associated with the second light beam could be less while the peak of the second main wavelength W2 shifts toward a long wavelength direction (see curve C52). When the yellow toner is mixed into the medium layer, the first main wavelength W1 of the second light beam may have larger peak attenuation (see curve C53) and the first main wavelength W1 consequently has larger peak attenuation than the peak attenuation of the second main wavelength W2. When the yellow toner and the red toner are mixed together into the medium layer, the first main wavelength W1 of the second light beam may have higher peak attenuation (See curve C54) to make the peak attenuation of the first main wavelength W1 larger than the peak attenuation of the second main wavelength W2 and make the peak of the second main wavelength W2 shift toward a long wavelength direction (e.g., shifting approximately from 560 nm to 580 nm) Consequently, the general color rendering index Ra of the second light beam may be increased approximately from 65 to 70.

One implementation for the aforementioned medium layer mixing with the red toner and the yellow toner may be the red toner is mixed into a yellow mixture material having the yellow toner and materials, such as plastic materials, glass materials or optical materials, and then a color plate or lamp cover is manufactured by injection or extrusion molding. Additionally, the other implementation may be implemented through mixing the red and yellow toners into two separated layer of different plastic materials to equivalent to a single layer medium layer having the red and yellow toners mixed therein.

It is worth to note that the weight percent concentration of the red toner in the medium layer may be in the range of about 0 wt % to about 1 wt % (0 wt % is not included), wherein the red toner has a preferable weight percent concentration in the medium layer of about 0 wt % to about 0.02 wt %, (If the medium layer has no the red toner mixed therein, the weight percent concentration of the red toner is 0 wt %). Moreover, the weight percent concentration of the yellow toner in the medium layer may be in the range 0 wt % to 5 wt % (0 wt % is excluded), and similarly with a preferable weight percent concentration of about 0.05 wt % to about 0.1 wt % relative to the medium layer.

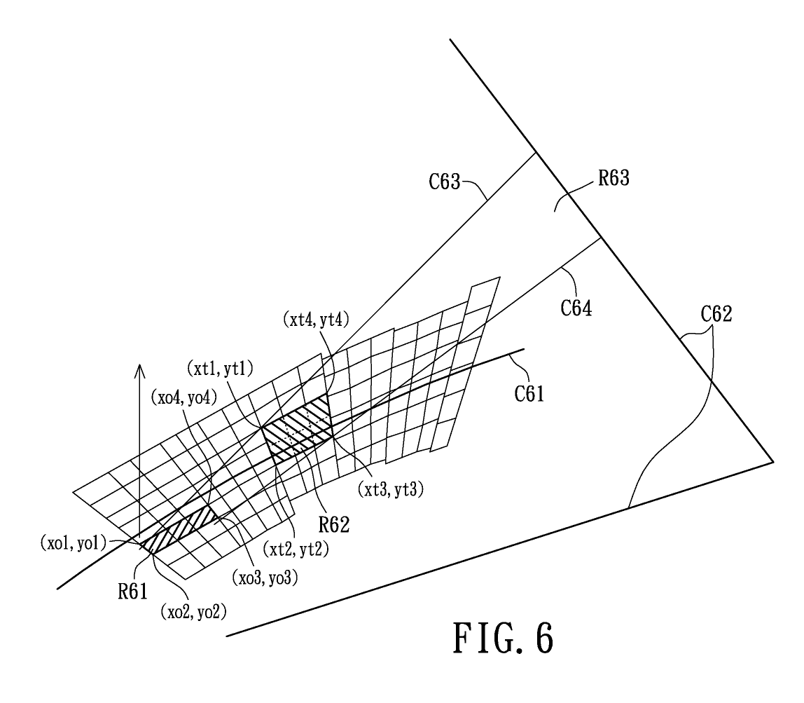

In FIG. 6, the curve C61 represents the blackbody locus, and the curve C62 represents the saturation curve of the CIE 1931 chromaticity coordinate diagram. The curves C63 and 64 represent respective boundary color coordinate point lines of respective first boundary color coordinate points in the chromaticity region associated with a first light beam connecting to corresponding second boundary color coordinate points in the chromaticity region associated with a second light beam.

Supposing the chromaticity region in accordance to the first light beam emitted by the light source is a region R61, a region R62 represents the chromaticity region in accordance to the second light beam generated after the first light beam passes through the medium layer. The boundary color coordinate point lines C63 and C64 are generated by connecting each of the first boundary color coordinate points in the chromaticity region R61 associated with the first light beam to the respective second boundary color coordinate point corresponding to the first boundary color coordinate point in the chromaticity region R62 associated with the second light beam. Next, a toner chromaticity region R63 is enclosed by the boundary color coordinate point lines C63 and C64 and the saturation curve C62. Finally, at least one chromaticity from the toner chromaticity region R63 is selected as the color of the toner in the medium layer.

In this embodiment, the first boundary color coordinate points in the chromaticity region R61 are (xo1, yo1), (xo2, yo2), (xo3, yo3), and (xo4, yo4), respectively. The second boundary color coordinate points in the chromaticity region R62 are (xt1, yt1), (xt2, yt2), (xt3, yt3), and (xt4, yt4), respectively. Hence, the connection lines of the first boundary color coordinate points in the chromaticity region R61 associated with a first light beam connecting to the respective second boundary color coordinate points in the chromaticity region R62 associated with a second light beam (i.e. the boundary color coordinate point line) may be expressed as follow:

$$Y = \frac{yti - yoi}{xti - xoi} X + ( yoi - \frac{xoi \times yti - xoi \times yoi}{xti - xoi} ) ,$$

where i is an integer from 1 to 4. In addition, a segment of the saturation curve C62 connecting the boundary color coordinate point lines C63 and C64 may be expressed as Y=−X+0.99. More specifically, the segment between an intersection of the saturation curve C62 and the boundary color coordinate point line C63 to an intersection of the saturation curve C62 and the color coordinate point line C64 may be expressed as Y=−X+0.99.

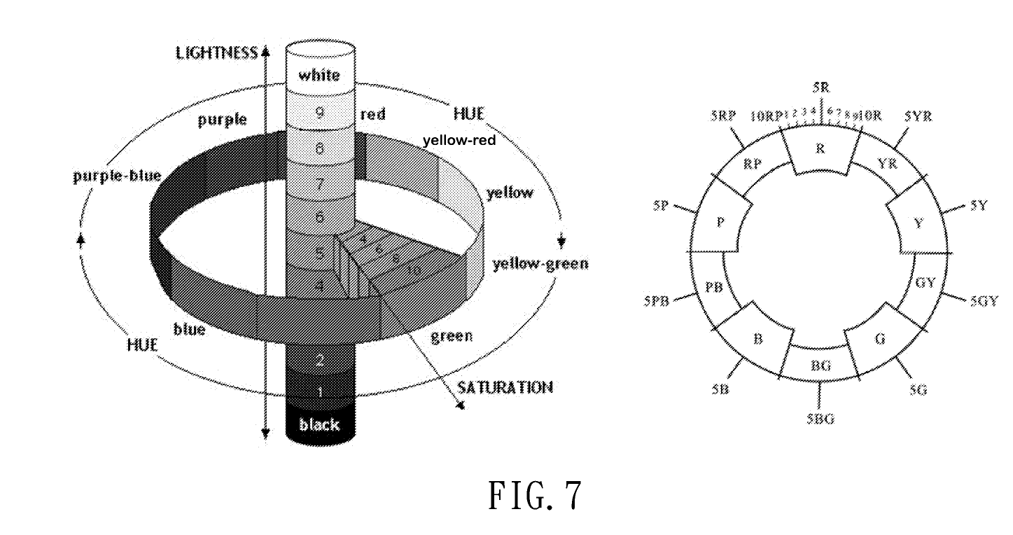

Referring to FIG. 7, a vertical axis describes the lightness, a radial axis describes the saturation, and an angular axis describes the hue according to the Munsell color system. The yellow toner may select at least a hue of 1YR to 10Y in accordance to the Munsell color system, and the yellow toner has no limitation on the corresponding brightness and saturation. If the brightness and the saturation of the selected yellow toner are low, the required amount of yellow toner (i.e. the weight percent concentration) may be respectively high. Conversely, if the brightness and saturation of the selected yellow toner are high, the required amount (or the weight percent concentration may be respectively low. In this embodiment, the yellow toner has a color of 7.5Y8/10 or 5Y8/13, and the yellow toner has a preferable weight percent concentration in the range of about 0.05 wt % to about 0.1 wt %. Within the present disclosure, the red toner may select at least a hue from 4R to 6R in accordance to the Munsell color system, and the red toner has no limitation on the corresponding lightness and saturation. Further, the weight percent concentration of the red toner may be less than about 1 wt %, with a preferable weight percent concentration less than about 0.02 wt %.

The medium layer allocated in the lighting apparatus may be implemented by mixing toners into a single layer or on a multi-layer, or applying a double injection process.

An implementation for adopting the single layer with a toner mixed therein to fabricate the medium layer is provided herein. In practice, the diffusion material is added to the conventional lamp cover for preventing hot spots, hence the toner may be mixed with the diffusion material, glass or, plastic. Then, the lamp cover is formed by the extrusion molding or injection molding without modifying the mold. Thus the lamp cover may possess an effect as the foregoing medium layer. Additionally, the toner may be mixed into secondary components (for example, secondary lens, diffuser, or light guide) or into the light emitting surface of light source to accomplish the medium layer. In addition, other methods for mixing toners may be provided by a material provider to produce well mixed materials at the source-end or by an injection factory and/or an extrusion factory to mix toners at the preprocessing station.

An implementation for adopting the multi-layer with a toner mixed therein to fabricate the medium layer is provided herein. In practice, the diffusion material is added to the conventional lamp cover to prevent hot spots. If the appearance of the lamp cover would be not changed, i.e. to keep the original color, the toner can be mixed into plastic or glass-made plates disposed in between the light source and the lamp cover. Accordingly, the first light beam after passing through the described plate changes its properties, such as a peak variation, a wavelength shift, a color deviation variation or a color temperature adjustment and a second uniform light beam after passing through the lamp cover with the diffusion material is generated. Moreover, a plate can be made by addition of the toner with a lower concentration and plural layers of the plates can be superposed, and reduction of the color temperature, peak attenuation of main wavelength or the color deviation in the lighting apparatus may be varied in accordance to the plate thickness.

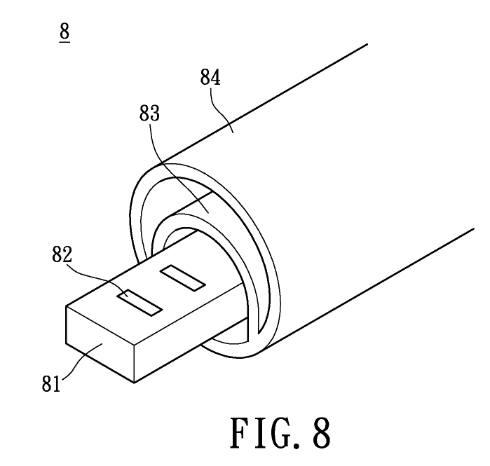

An implementation for adopting the double injection to fabricate the medium layer is provided herein. The lamp cover is usually formed by a secondary component. An external part of the secondary component is made of plastics with diffusion material while an internal part of the secondary component is made of plastics with toner mixed therein keep the original color or appearance in the lamp cover. As shown in FIG. 8, a lighting apparatus 8 includes a light source 81, a plate 83 with toner mixed therein, and a lamp cover 84. The light source 81 has a plurality of light-emitting diodes 82 for emitting a first light beam, such as white light, with different color temperatures to generate a first color temperature range. After the first light beam emitted by the light-emitting diodes 82 of the light source 81 passes through the plate 83 and the lamp cover 84, a second light beam, such as white light, with a second color temperature range, is generated, wherein the first color temperature range is greater than the second color temperature range thereby generating a relatively uniform second light beam. Moreover, the plate 83 with toner mixed therein and the lamp cover 84 are fabricated by the double injection process.

According to experiments, when the yellow toner with 0.05 wt % is mixed into the medium layer, a second light beam having the color temperature in the range of 6000K to 81000K is generated after the first light beam with the first color temperature in the range of 7000K to 13000K passes through the medium layer. When adopting yellow toner in an amount of 0.1 wt % into the medium layer, the second light beam having the color temperature in the range of 5500K to 6800K is generated after the first light beam with the first color temperature in the range of 7000K to 13000K passes through the medium layer. When using both medium layers, i.e. two medium layer respectively having yellow toners of 0.05 wt % and 0.1 wt %, at same time, the second light beam having the color temperature in the range of 6000K to 6800K is generated after the first light beam with the first color temperature in the range of 7000K to 13000K passes through the two medium layers.

Furthermore, the higher the color temperature, the larger the reduction in the color temperature. Moreover, the more the concentration of the yellow toner, the more the reduction in the color temperature. The more the thickness of the medium layer, the more the reduction in color temperature.

It may be noted from the above, the user may use more than two medium layers to increase the reduction in the color temperature. In summary, the medium layer of the lighting apparatus disclosed in the exemplary embodiment of the present disclosure may cause changes in the properties associated with a light beam after the light beam passes through the medium layer. Take some examples as follows. The color temperature of the light beam passing through the medium layer may be lowered than the color temperature of the light beam bypassing the medium layer. The peak attenuation of the main wavelength associate with the short wavelength portion of the light beam passing through the medium layer may be larger than the peak attenuation of the main wavelength associated with the long wavelength portion of the light beam passing through the medium layer. The main wavelength associated with the long wavelength portion of the light beam passing through the medium layer may experience redshift. The absolute value of the color deviation between the blackbody locus and the light beam passing through the medium layer may be less than the absolute value of the color deviation between the blackbody locus and the light beam without passing through the medium layer. Furthermore, the medium layer may not cause significant reduction in general color rendering index, lighting quality, and optical efficiency associated with the light beam.

Consequently, the manufacturers may not need to purchase light-emitting diode with certain standards as light sources, and therefore the associated fabrication cost is reduced. Additionally, the replaceability of the medium enhances applications of the lighting apparatuses.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A lighting apparatus, comprising:
a light source, emitting a first light beam having a first main wavelength and a second main wavelength, wherein the first main wavelength is less than the second main wavelength; and
at least a medium layer, allocated corresponding to the light source, the medium layer has a transmittance not less than 60% and a toner mixed therein, after the first light beam passes through the medium layer, a peak attenuation of the first main wavelength is larger than that of the second main wavelength.

2. The lighting apparatus according to claim 1, wherein a second light beam is generated after the first light beam passes through the medium layer.

3. The lighting apparatus according to claim 2, wherein the first light beam has a color temperature higher than that of the second light beam.

4. The lighting apparatus according to claim 3, wherein the first light beam has the color temperature in range of 7000K to 13000K, and the second light beam has the color temperature in range of 5500K to 8100K.

5. The lighting apparatus according to claim 2, wherein an absolute value of a color deviation associated with the first light beam is larger than that associated with the second light beam.

6. The lighting apparatus according to claim 1, wherein an absolute value of a color deviation associated with the first light beam is larger than 0.006.

7. The lighting apparatus according to claim 1, wherein the toner is a powder toner or a liquid toner.

8. The lighting apparatus according to claim 1, wherein the toner comprising a yellow toner.

9. The light apparatus according to claim 8, wherein the yellow toner has a weight percent concentration of about 0 wt % to about 5 wt % relative to the medium layer.

10. The light apparatus according to claim 8, wherein the yellow toner has a hue in the range of 1YR to 10Y according to the Munsell color system.

11. The light apparatus according to claim 8, wherein the toner further comprising a red toner for redshifting the second main wavelength after the first light beam passes through the medium layer.

12. The lighting apparatus according to claim 11, wherein the red toner has a weight percent concentration less than or equal to about 1 wt % relative to the medium layer.

13. The lighting apparatus according to claim 2, wherein the toner has a hue selected from a toner chromaticity region formed by connecting a saturation curve and a plurality of boundary color coordinate point lines, each of boundary color coordinate point lines being a connection line between one of a plurality of first boundary color coordinate points in a chromaticity region of the first light beam and a second boundary color coordinate point corresponding to the one of first boundary color coordinate points in a chromaticity region of the second light beam.

14. The lighting apparatus according to claim 2, wherein the toner has a hue selected from a toner chromaticity region, with the first light beam having boundary color coordinate points of (xoi, yoi) and the second light beam having boundary color coordinate points of (xti, yti), wherein i is an integer from 1 to 4, and the toner chromatic region is given by the following expressions,
$$Y = \frac{yti - yoi}{xti - xoi} X + ( yoi - \frac{xoi \times yti - xoi \times yoi}{xti - xoi} ) ; and$$
$$Y = - X + 0.99$$

15. A lighting apparatus, comprising:
a light source, emitting a first light beam having an absolute value of a color deviation from a blackbody locus larger than 0.006; and
at least a medium layer, allocated on an optical path of the light source, the medium layer having a toner mixed therein and a transmittance not less than 60%, wherein a second light beam is generated after the first light beam passes through the medium layer, and the second light beam has an absolute value of a color deviation from the blackbody locus is less than that of the first light beam.

16. The lighting apparatus according to claim 15, wherein the first light beam has a first main wavelength and a second main wavelength, and the first main wavelength is less than the second main wavelength.

17. The lighting apparatus according to claim 16, wherein, after the first light beam passes through the medium layer, the first main wavelength of the first light beam has a peak attenuation larger than that of the second main wavelength.

18. A selecting method for selecting a hue of the toner in the medium layer of the lighting apparatus according to claim 1, and the selecting method comprising:
forming a plurality of boundary color coordinate point lines by respectively connecting each of a plurality of first boundary color coordinate points in a chromaticity region associated with the first light beam to one of a plurality of second boundary color coordinate points corresponding to the respective first boundary color coordinate point in a chromaticity region associated with the second light beam;
forming a toner chromaticity region enclosed by the boundary color coordinate point lines and a saturation curve; and
selecting the hue of the toner from the toner chromaticity region.

19. The selecting method according to claim 18, wherein the hue of the toner is a hue selected from 1YR to 10Y according to the Munsell color system.
